(19) United States
(12) Patent Application Publication
(10) Pub. No.: US 2019/0337358 A1
(43) Pub. Date: Nov. 7, 2019

(54) CONTROLLING PASSENGER CABIN CLIMATE USING LOCAL WEATHER DATA

(71) Applicant: FORD GLOBAL TECHNOLOGIES, LLC, Dearborn, MI (US)

(72) Inventor: William J. Wamsley, Willis, MI (US)

(21) Appl. No.: 15/970,141

(22) Filed: May 3, 2018

(51) Int. Cl. B60H 1/00; G08G 1/0967

(52) U.S. Cl. CPC B60H 1/00978; G08G 1/0967; B60H 1/00807

(57) ABSTRACT

Methods and systems for selecting an ambient temperature value for initializing an ambient temperature algorithm in a vehicle climate control system are described. The methods and systems include, by a controller, determining a risk that a prior stored ambient temperature value is inaccurate by comparing to a remotely sourced current ambient temperature value and calculating a risk factor. The controller selects an ambient temperature algorithm input from one of the prior stored ambient temperature value or a new ambient temperature value according to the calculated risk factor.

### TECHNICAL FIELD

This disclosure relates generally to vehicle climate control systems. More particularly, the disclosure relates to a control system for automatically controlling and adjusting a vehicle passenger cabin climate according to vehicle-exterior ambient temperature. The disclosure further relates to a control system configured to select an ambient temperature input for initializing a climate control module ambient temperature algorithm according to a calculated risk factor that a stored ambient temperature value has become outdated, and to replace the stored value with a current ambient temperature value.

### BACKGROUND

Various systems and mechanisms are provided in the modern vehicle for establishing and maintaining vehicle occupant comfort, primarily mediated by way of the vehicle climate control systems, for example the heating, air-conditioning, and ventilation (HVAC) systems. In operating such systems and mechanisms, typically the vehicle occupant is required to exercise some element of manual control to adjust the mechanisms to his or her satisfaction. Climate control systems often require extensive user interaction to produce the desired result on passenger cabin comfort levels according to particular external and internal climate conditions.

To reduce the required level of user input in controlling passenger cabin comfort, it is known to provide a vehicle with an HVAC system operatively linked to climate control modules including controllers. The controllers are configured to receive inputs reflective of ambient conditions such as extra-vehicular temperature, weather conditions, etc., and to control the HVAC system accordingly to adjust passenger cabin climate to a desired level of comfort. As will be appreciated, passenger cabin “climate” may include a number of adjustable variables, including without intending any limitation temperature, humidity, and others.

In making such passenger cabin climate adjustments, climate control modules/controllers may rely on an ambient temperature algorithm. Many examples of such ambient temperature algorithms are known. However, at a high level, these algorithms refer to a stored or a determined extra-vehicular ambient temperature in order to select a setting for the HVAC system that will adjust a passenger cabin climate to a desired level of passenger comfort. For example, at a particular determined ambient temperature, a controller associated with the climate control module may refer to a look-up table and select the appropriate HVAC setting therefrom. The HVAC setting may provide a desired HVAC operating mode, HVAC airflow setting, airflow temperature, airflow humidity, etc. to provide the desired passenger cabin comfort level.

Most commonly, the controller utilizes a stored ambient temperature value in order to reduce the processing capacity required to provide this information. The stored ambient temperature value, which may be obtained from one or more onboard temperature sensors or remotely, such as from a remotely located weather database, is periodically refreshed to ensure that it does not become inaccurate. By “inaccurate,” it is of course meant that the stored ambient temperature value no longer accurately matches the current ambient temperature data. This can occur for a number of reasons, including without intending any limitation passage of time between steps of storage of an ambient temperature value, a long period of engine idle wherein engine heat interferes with an accurate determination of ambient temperature by an on-board ambient temperature sensor, etc.

Stored ambient temperature data is typically used to initialize an ambient temperature algorithm by the climate control module/controller. However, as noted above the last-stored ambient temperature value may not be correct, i.e. may not accurately reflect the current ambient temperature. For example, depending on the season/time of year and the length of time of engine inactivity between algorithm initialization procedures, the last-stored ambient temperature value may differ from the actual current ambient temperature value by as much as 30° C. Further, during prolonged engine idle, changes in ambient temperature may not be accurately detected by on-board ambient temperatures sensor systems since, without any cooling airflow provided by vehicle movement, the idling engine heat may interfere with accurate on-board ambient temperature sensor readings.

### SUMMARY

In accordance with the purposes and benefits described herein and to solve the foregoing and other problems, in one aspect of the present disclosure methods are described for selecting an ambient temperature value for initializing an ambient temperature algorithm in a vehicle climate control system. The methods comprise, by a controller, determining a risk that a prior stored ambient temperature value is inaccurate by comparing to a remotely sourced current ambient temperature value and calculating a risk factor. The controller then selects an ambient temperature algorithm input from one of the prior stored ambient temperature value or a new ambient temperature value according to the calculated risk factor. The controller may be provided associated with a vehicle climate control module in operative communication with the vehicle climate control system. The method may include, by the vehicle climate control system under control of the vehicle climate control module, adjusting a vehicle passenger cabin climate according to the ambient temperature algorithm.

In embodiments, the controller calculates the new ambient temperature value as a function of the prior stored ambient temperature value, the calculated risk factor, and the remotely sourced current ambient temperature value. The new ambient temperature value may be stored in memory by the controller. In embodiments, the controller selects the new ambient temperature value only if the calculated risk factor equals or exceeds a predetermined threshold risk factor.

The controller may receive one or more remotely located weather database inputs to determine the remotely sourced current ambient temperature value. These may be selected according to a determined vehicle geographic position.

In another aspect, a system for implementing the described method is provided, comprising a vehicle climate control module comprising a controller in operative communication with a vehicle climate control system. The controller is configured as described above.

In the following description, there are shown and described embodiments of methods and systems for initializing a vehicle climate control system ambient temperature algorithm. As it should be realized, the disclosed methods and systems are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed methods and systems for for initializing a vehicle climate control system ambient temperature algorithm, and together with the description serve to explain certain principles thereof. In the drawing:

FIG. 1 schematically depicts a vehicle including an embodiment of a system for automatically controlling and adjusting a vehicle passenger cabin climate according to vehicle-exterior ambient temperature;

FIG. 2 graphically illustrates an embodiment of a method for initializing an ambient temperature algorithm during operation of a vehicle passenger cabin climate system; and

FIG. 3 graphically illustrates in greater detail a method for selecting one of a stored ambient temperature value and a new ambient temperature value for initializing the ambient temperature algorithm of FIG. 2; and

Reference will now be made in detail to embodiments of the disclosed methods and systems, examples of which are illustrated in the accompanying drawing figures.

### DETAILED DESCRIPTION

At a high level, the present disclosure is directed to methods for automatically controlling settings of a vehicle climate control system, and to systems implementing the methods. The methods and systems, in certain situations, automate the climate control system controls, including without intending any limitation such elements as temperature setpoints, recirculation settings, actuation of various elements of the climate control system such as the air-conditioning (AC) mode, heater mode, defrost mode, etc., HVAC blower speed settings, airflow humidity, and others. Preliminarily, the various aspects and specific devices associated with a vehicle HVAC system, climate control system, climate control module, etc. as described herein are well known in the art and do not require extensive description herein. In turn, the manner of operation of these various aspects and specific devices are also well known in the art. These features are shown herein in block form for convenience and ease of illustration.

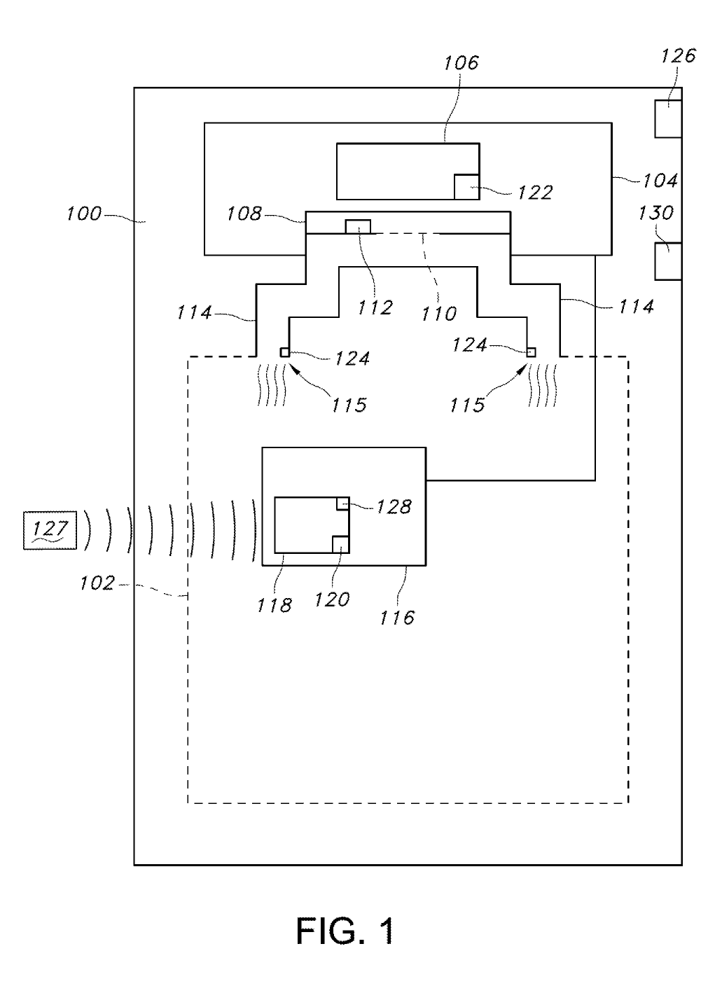

FIG. 1 illustrates a vehicle 100 including a passenger cabin 102. The vehicle 100 includes an HVAC system 104, which in turn comprises at least an HVAC evaporator core 106. The HVAC system 104 further includes an HVAC blower 108 in fluid communication with an HVAC air distribution door 110. As is known, the HVAC air distribution door 110 may be automatically controlled by way of an actuator 112 controlling mechanical linkages (not shown) of various designs. The HVAC air distribution door 110 in turn places the HVAC blower 108 in fluid communication with an HVAC duct system 114 via which conditioned airflow is introduced into the passenger cabin 102 by way of air registers 115.

A climate control system 116 is in operative communication with the HVAC system 104. By the climate control system 116, the HVAC system 104 may automatically or by user command control an amount and a temperature of airflow introduced into the passenger cabin 102. Operative control is provided by a climate control module (CCM) 118 comprising at least a controller 120 provided with one or more processors, one or more memories, and storage comprising logic configured for controlling the vehicle HVAC system 104.

The CCM 118/controller 120 may further be in communication with a variety of sensors, including without intending any limitation at least a vehicle-exterior ambient temperature sensor system 126 comprising one or more on-board ambient temperature sensors, a remotely located weather database 127 such as a weather service, and others. The remotely located weather database 127 may communicate with the CCM 118/controller 120 by any suitable wireless technology. As will be appreciated, the data provided by the remotely located weather database 127 will periodically update or refresh, and new information will be sent to the CCM 118/controller 120. The controller 120 or another vehicle controller such as the BCM (not shown) may include a timer 128 which automatically begins running on cessation of operation of the vehicle 100, the HVAC system 104, etc.

The vehicle 100 may further be provided with a geographical location system 130 which can accurately determine a geographical position of the vehicle and communicate such position as an input to the controller 120 or another vehicle-associated controller. A number of such geographical location systems 130 are known, such as Global Positioning Satellite technology. As will be described, in embodiments the geographical location system 130 may be used to determine a geographical position of the vehicle 100, which in turn will inform the inputs received from the remotely located weather database 127 accordingly to provide inputs of temperature, weather conditions, etc. according to the vehicle's determined geographical location. The remotely located weather database 127 and the geographical location system 130 may communicate with/be associated with various vehicle components, for example with Ford Motor Company's SYNC® integrated in-vehicle communications and entertainment system.

With the foregoing as background, the present disclosure provides methods for controlling the climate control system 116 by way of the CCM 118/controller 120 according to vehicle-exterior ambient temperature. At a high level, the methods comprise comparing a stored ambient temperature value to a current ambient temperature value received from the remotely located weather database 127, and by the controller 120, calculating a risk factor that the stored ambient temperature value is outdated. According to that calculated risk factor, one of the stored ambient temperature value and the remotely sourced ambient temperature value is selected and used as an ambient temperature input to initialize an ambient temperature algorithm. The CCM 118 then establishes a comfort level for passenger cabin 102 according to the initialized ambient temperature algorithm by actuating elements of the vehicle HVAC system 104 as needed.

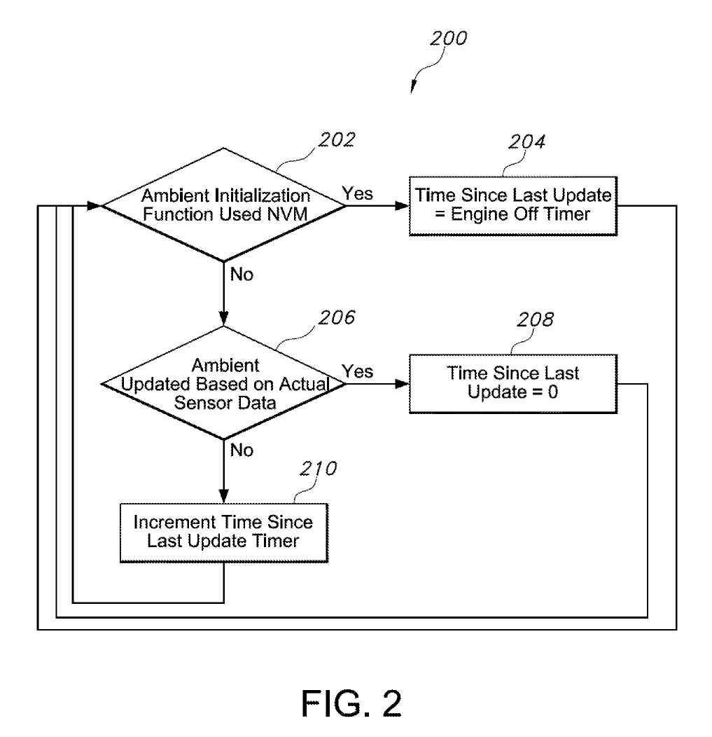

FIG. 2 illustrates a method 200 for controlling the climate control system 116 by way of the CCM 118/controller 120 according to vehicle-exterior ambient temperature, and specifically for selecting a value for a “time since last update” for the system 116, i.e. for updating an ambient temperature value for use in initializing the system. If the stored ambient temperature value is to be used (step 202), the CCM 118/controller 120 sets a “time since last update” value to the vehicle 100 engine off time value (step 204). This can be obtained from the vehicle CAN bus. In this way, the CCM 118/controller 120 selects a latest stored ambient temperature value to initialize the system. On the other hand, if the system determines (step 206) that an updated ambient temperature value is to be used, at step 208 sets a “time since last update” value to 0, and a current ambient temperature value is selected to initialize the system. If neither of the above situations apply, then at step 210 the CCM 118/controller 120 simply increments the time since last update value.

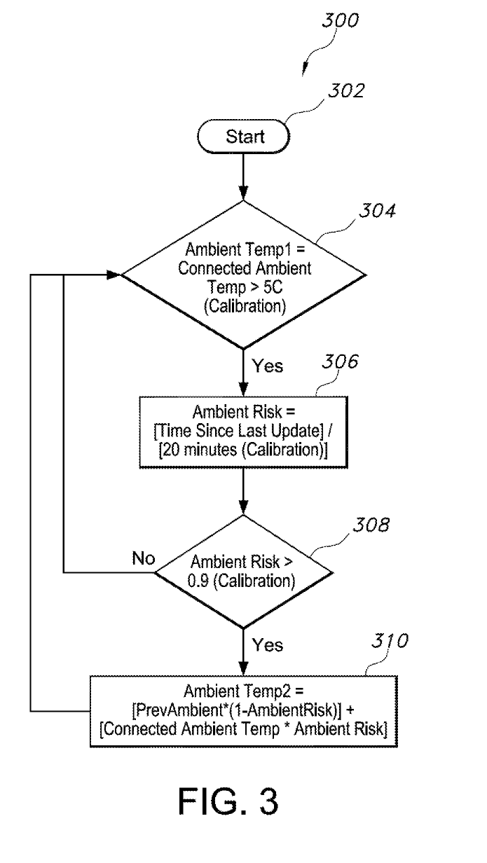

FIG. 3 illustrates a method 300 for controlling the climate control system 116 by way of the CCM 118/controller 120 according to vehicle-exterior ambient temperature, and specifically for determining whether an ambient temperature value used to initialize the system should be updated. At step 302, an event occurs requiring initialization of an ambient temperature algorithm associated with the CCM 118/controller 120, such as engine start-up or passage of a predetermined period of time since a previous update. At step 304 the controller 120 compares a stored (in memory) calculated ambient temperature value (Ambient Temp Stored1) to a current ambient temperature value (Connected Ambient Temp) received from the remotely located weather database 127. By stored calculated ambient temperature value, it will be appreciated that it is meant an ambient temperature value received by controller 120 as an input from the temperature sensor system 126, suitably filtered or otherwise adjusted to account for factors such as engine heat, vehicle speed, etc. that may influence accuracy of the temperature reading provided. As will be further appreciated, the current ambient temperature value received from the remotely located weather database 127 will vary according to a geographical location of the vehicle, determined by the geographical location system 130. Such technology is known in the art.

Specifically, in the depicted embodiment a difference between the stored calculated ambient temperature value and the current ambient temperature value received from the remotely located weather database 127 is determined. If the difference equals or exceeds a predetermined temperature differential threshold, at step 306 a risk factor of the stored calculated ambient temperature value being outdated is calculated. If not, the process returns to step 304. In the depicted embodiment, a predetermined temperature differential threshold of 5° C. is utilized at step 304. However, other predetermined temperature differential thresholds are possible and contemplated.

If at step 304 the predetermined temperature differential threshold is met or exceeded, at step 306 a risk factor (Ambient Risk) is calculated that the stored calculated ambient temperature value is inaccurate. In the depicted embodiment, the risk factor is determined as passage of time since a prior step by CCM 118/controller 120 of storing an ambient temperature value (TimeSinceLastUpdate)/20 min. This provides a linear calculated risk factor that the most recently stored calculated ambient temperature value is inaccurate due to extended engine idling or extended passage of time between steps of storing calculated ambient temperature values. The calculated risk factor is typically bounded as a numerical value between 0 and 1.

If the risk factor exceeds a predetermined risk threshold value, at step 310 a new stored calculated ambient temperature value is determined. In the depicted embodiment, a risk threshold value of >0.9 is used. However, higher or lower threshold figures are possible and contemplated. As will be appreciated, this avoids unnecessary updating such as for example during short periods of engine idle.

In the depicted embodiment, if the calculated risk factor exceeds the predetermined risk threshold value, at step 310 a new calculated ambient temperature value (Ambient Temp2) is calculated as a function of the previous stored calculated ambient temperature value (PrevAmbient), the risk factor (AmbientRisk), and the current ambient temperature value received from the remotely located weather database 127 (Connected Ambient Temp). In the depicted embodiment, this is illustrated as the equation AmbientTemp2=PrevAmbient*(1−AmbientRisk)+ConnectedAmbientTemp*AmbientRisk. The new calculated ambient temperature value is then stored and used to initialize the ambient temperature algorithm by the CCM 118/controller 120.

Obvious modifications and variations are possible in light of the above teachings. All such modifications and variations are within the scope of the appended claims when interpreted in accordance with the breadth to which they are fairly, legally and equitably entitled.

What is claimed:

1. A method for selecting an ambient temperature value for initializing an ambient temperature algorithm in a vehicle climate control system, comprising:
by a controller, determining a risk that a prior stored ambient temperature value is inaccurate by comparing to a remotely sourced current ambient temperature value and calculating a risk factor; and
by the controller according to the calculated risk factor, selecting an ambient temperature algorithm input from one of the prior stored ambient temperature value or a new ambient temperature value.

2. The method of claim 1, including providing the controller associated with a vehicle climate control module in operative communication with the vehicle climate control system.

3. The method of claim 2, further including, by the vehicle climate control system under control of the vehicle climate control module, adjusting a vehicle passenger cabin climate according to the ambient temperature algorithm.

4. The method of claim 1, including, by the controller, calculating the new ambient temperature value as a function of the prior stored ambient temperature value, the calculated risk factor, and the remotely sourced current ambient temperature value.

5. The method of claim 4, further including, by the controller, storing the new ambient temperature value in memory.

6. The method of claim 1, including, by the controller, selecting the new ambient temperature value only if the calculated risk factor equals or exceeds a predetermined threshold risk factor.

7. The method of claim 1, including, by the controller, receiving one or more remotely located weather database inputs to determine the remotely sourced current ambient temperature value.

8. The method of claim 7, including selecting the one or more remotely located weather database inputs according to a determined vehicle geographic position.

9. A system for selecting an ambient temperature value for initializing an ambient temperature algorithm in a vehicle climate control system, comprising:
a vehicle climate control module comprising a controller in operative communication with a vehicle climate control system, wherein the controller is configured to:
determine a risk that a stored ambient temperature value is inaccurate by comparing to a remotely sourced current ambient temperature value; and
according to a calculated risk factor, provide an ambient temperature algorithm input by selecting one of the stored ambient temperature value or a new ambient temperature value.

10. The system of claim 9, wherein the vehicle climate control module is adapted to determine an operative setting of the vehicle climate control system to adjust a vehicle passenger cabin climate according to the ambient temperature algorithm.

11. The system of claim 9, wherein the controller is further configured to calculate the new ambient temperature value as a function of the stored ambient temperature value, the calculated risk factor, and the remotely sourced current ambient temperature value.

12. The system of claim 11, wherein the controller is further adapted to store the new ambient temperature value in memory.

13. The system of claim 9, wherein the controller is further configured to select the new ambient temperature value for the input only if the calculated risk factor equals or exceeds a predetermined threshold risk factor.

14. The system of claim 9, wherein the remotely sourced current ambient temperature value is provided to the controller as one or more ambient temperature inputs received from a remotely located weather database.

15. The system of claim 14, wherein the one or more ambient temperature inputs are selected according to a determined vehicle geographic position.
